(19) United States
(12) Patent Application Publication
(10) Pub. No.: US 2026/0216782 A1
(43) Pub. Date: Jul. 30, 2026

(54) Process for embossing microgrooves in light-reflecting sheet metal

(71) Applicant: Helmut Koester, Frankfurt (DE)

(72) Inventor: Helmut Koester, Frankfurt (DE)

(21) Appl. No.: 19/145,190

(22) PCT Filed: Dec. 23, 2023
(86) PCT No.: PCT/EP2023/087782

§ 371 Date: Jul. 1, 2025

(30) Foreign Application Priority Data
Jan. 3, 2023 (DE) 10 2023 200 054.7

(51) Int. Cl. B21H 8/00; B29C 59/04; B32B 3/30; B32B 15/08; B32B 15/20; E06B 9/24; E06B 9/386

(52) U.S. Cl. CPC B21H 8/005; B29C 59/046; B32B 3/30; B32B 15/08; E06B 9/386; B32B 15/20; B32B 2307/54; B32B 2307/7376; E06B 2009/2482

(57) ABSTRACT

The invention relates to a process for embossing groove-shaped microstructures into thin-walled sheet metal between two hard rollers for the production of louvre blinds with at least partially metallic reflective and at least partially grooved upper surfaces for light deflection.

The following process steps apply:
Arrangement of a thin, soft, elastic and/or plastic layer of plastic beyond the embossed sides
Creating a groove by embossing V-shaped grooves which run in the longitudinal direction of the slit strip to be embossed,
wherein the grooving is embossed in throughfeed between one or more pairs of rollers, wherein a pair of rollers consists of a hard embossing roller with a groove-shaped contour and a hard counterpressure roller without grooves, wherein the counterpressure roller is hard in relation to the soft embossing base formed by the thin, soft, elastic and/or plastic layer of plastic material
wherein the embossing is carried out in the thin sheet metal strip by embossing through the thin sheet metal into the soft plastic layer and
wherein the counter-pressure roller has a smooth, elastic, but harder or hard surface in relation to the embossing base, so that
the thin, soft, elastic and/or plastic layer of plastic is crushed more strongly in the area of the groove edges and
the squeezed, soft, elastic and/or plastic plastic layer is squeezed into the groove valleys between the groove edges, so that
the squeezing of the soft, elastic and/or plastic layer of plastic material at the groove edges causes the thin sheet to support a positive moulding in the groove valleys of the embossing roller as a result of
by squeezing the soft, elastic and/or plastic plastic layer at the grooved edges, the thin sheet supports a form-fitting moulding in the groove valleys of the embossing roller due to displacement and thus a thin sheet grooved on both sides can be produced by means of a smooth counter-pressure roller without grooves.

### CROSS REFERENCE TO RELATED APPLICATIONS

This nonprovisional application is a national stage entry of PCT Application No. PCT/EP2023/087782, filed Dec. 23, 2023, which in turn claims the benefit of priority under 35 USC § 119 to German Patent Application No. 10 2023 200 054.7, filed on Jan. 1, 2023, the entirety of which are incorporated herein by reference.

### BACKGROUND OF THE INVENTION

### Field of the Invention

The invention relates to a continuous process for embossing groove-shaped microstructures in thin-walled sheet metal between two rollers, one roller having a groove-shaped contour and the counter-pressure roller having an essentially smooth surface, primarily as a preliminary product for use as a louvre blade with Fresnel optics.

### Description of the Background

An embossing process is usually understood to be the pressing of an embossed structure into a soft material, e.g. paper or leather. During the embossing process, the soft material is squeezed together on a smooth surface to create a depression in the workpiece. The underside of the embossed material remains flat, without embossing. This is possible because the embossing substrate is hard and the workpiece to be embossed is soft and thick enough to provide penetration depth.

This process is also used to emboss aluminium sheets with an initial thickness of 0.55 mm in the form of grooves, whereby the aluminium strips are grooved on one side by an embossing roller and the counter-pressure roller is hard and smooth so that only the upper side is grooved. The depth of the creasing is then at best 0.4 mm, i.e. less than the material thickness. The raised groove tips build up by 0.1 mm, resulting in a total thickness of 0.65 mm after embossing. The creasing is produced by a so-called kneading process in the strip material. Plastic moulding takes place.

The disadvantage of this embossing process between two hard rollers is the need for a thick sheet in order to create a deepening embossing impression in the material. This requires a large amount of material and sometimes causes weight problems later on and is only suitable for very soft materials that can be plastically moulded.

It is also known from DE102018209927 A1 that thin sheet metal strips for blind slats are grooved on both sides by means of two profiled rollers, whereby the strip is driven through between two grooved rollers. The strip is stretched between the tips of the rollers and formed into a sawtooth-like contour with one tooth next to the other. The result can be seen in a photo in FIG. 1 on a scale of 20:1. The surfaces of the folds are no longer suitable for directional reflection.

Here the forming is based on material stretching between roller tips. This introduces stresses into the material which, at least in the case of alloyed aluminium, are no longer released in subsequent straighteners as the material has hardened. During this forming process, a narrow strip bowls and/or rotates as a result of the stress that is stored in the material structure during forming (corkscrew effect). This also means that the tooth contour cannot be moulded precisely and anodised primary material cannot be processed. The anodised surface cracks and loses its mirror finish.

It is known from DE 10 2021 206846.4 to force a strip between two grooving rollers with an exact roller contour through the roller gap, which has the nominal contour of the grooved sheet to be formed. Here, the peaks and valleys in the mould must be exactly opposite each other in order to avoid introducing asymmetrical tension into the material to be grooved. In reality, it is hardly technically possible to adjust the tools precisely enough due to bearing tolerances in order to remove the material from the rolling process without tension, straight and without twisting. For the further development in the present innovation, it is important to design the process in such a way that an asymmetrical application of force in the groove moulding is prevented.

DE 10 2014 005480 A1 and DE 1001 18 451 A1 disclose a process for embossing asymmetrical groove structures. The disadvantage of asymmetrical structures is the risk of asymmetrical stress distribution in the embossed sheet, which leads to a so-called corkscrew effect in the rolling process that can no longer be eliminated by a straightener.

It is also known from Swiss patent specification 461 411 and EPO 900 131 D1 to use individual embossing punches, which are arranged in a distributed manner, to emboss strip material in a soft cushion in the form of dents in a rotary process in order to stiffen the strip material by means of the contours produced. Here, the contour of the embossing is left to the self-organisation of the workpiece, without achieving a precise moulding accuracy of the stamps. The soft cushion yields to the pressure, but does not enclose the embossing stamps, so that the result is not an exact moulding, but only a landscape of dents on the sheet.

In U.S. Pat. No. 4,059,000, longitudinal stamp impressions are made transversely to the strip so that the soft pad is only pressed in in places and the soft pad is relieved between the stamp impressions.

These processes differ fundamentally from the task of the innovation of producing a continuous creasing pattern in the longitudinal direction parallel to the edges of the belt material. The problem with continuous creasing is that the soft rubber padding builds up like a ‘bow wave’ in front of the roll gap due to the uninterrupted pressure and leads to destruction of the soft padding on the roll. High pressures are required to achieve a precise moulding of the embossing contour in the strip material. Experience shows that the thicker rubber pad, as can be found in the prior art, is torn off the roller or the rubber pad is quickly worn away on a roller due to the material jam in front of the roller gap according to U.S. Pat. No. 4,059,00, CH 461411, EP 0900131D1. It is technically impossible to realise process reliability in continuous groove moulding according to the state of the art.

### SUMMARY OF THE INVENTION

The invention has set itself the task of introducing a precise, groove-shaped contour into a thin slit strip of steel or aluminium with a high moulding accuracy of the embossing roller in the longitudinal direction of a slit strip, without the rubber support of the counter-pressure roller accumulating in front of the roll gap and without producing corkscrew effects and furthermore without destroying the mirror surface.

The task is, among other things, to produce a pre-material for blind slats from surface-finished thin sheet, e.g. from anodised strip, whereby a concave cross-sectional contour of the grooved slit strip at the end is to produce blind slats with Fresnel optics that reflect incident sunlight back into the sky. This requires a high moulding accuracy of prismatic grooves. The aim is to mould V-shaped grooves into the slit strip, whereby the legs of the grooves must be very smooth in order to reflect incident sunlight in a precisely directed manner. The angles of the V-shaped furrows must also be reproduced as precisely as possible in order to be able to focus the radiation by means of the furrow flanks. A further aim is to produce the raised tips of the groove structure with sharp edges so that the edges do not cause glare for interior users behind a blind or diffuse light scattering.

The primary aim is therefore to produce stable blind slats or a preliminary product for the manufacture of blinds.

In summary, the task is to achieve high process reliability and high moulding accuracy of a grooved roll without introducing stresses into the material during the forming process that could lead to cupping or twisting of the embossed slit strip. In particular, the raised points of the mirror prisms produced should be as sharp-edged as possible and the V-shaped groove flanks as smooth as possible.

### BRIEF DESCRIPTION OF THE DRAWINGS

It shows:

FIG. 1 (Prior Art) 20× magnification of a grooved thin sheet according to the state of the art.

FIG. 2 shows the layer structure of a thin sheet in combination with an elastic/plastic layer

FIG. 3 shows ideal contour of an embossed composite sheet in the mould pass

FIG. 4 shows venetian blind slat with a slat half grooved on the upper side

FIG. 5 shows the optical system on a slat with a grooved slat half and a non-grooved slat half

FIG. 6 shows a concave/convex slat with a smooth underside and an irregularly embossed groove structure on the upper side.

FIG. 7 shows a slat with central grooves and surfaces without grooves on the long sides.

FIG. 8 shows a slat with central grooves and surfaces without grooves on the long sides.

FIG. 9 shows a lamella with grooves over the entire cross-section.

FIG. 10 shows a lamella with grooves over the entire cross-section.

### DETAILED DESCRIPTION OF THE PREFERRED EMBODIMENTS

The solution to the problem follows from the main claim.

The claim teaches how the precision moulding is to be realised:
a. moulded between two hard rollers, whereby
b. a soft, elastic and/or plastic layer is located between the hard rollers, into which is moulded and a counter-pressure is generated by material displacement in the soft intermediate layer, which presses up the raised points of the groove on the rear side.
c. The elastic and/or plastic layer is, for example, a rubber skin on the counter-pressure roller and/or a film arranged on the underside of the slit strip to be embossed.
d. This film and/or the rubber skin on the roller is crushed at the embossing tips. The material displaced by the squeezing moves to the side and presses the slit strip into the grooves on the underside, so that V-shaped grooves are embossed on both sides with a positive fit.

This process requires the counter-pressure roller to be hard in relation to a soft embossing substrate. The counter-pressure roller can be made of steel, provided the foil is thick enough to press the grooves on the underside upwards into the groove contour of the embossing rollers. In the case of a rubber pad on the counter-pressure roller, this supports the pressure on the film.

The innovative process is particularly suitable for thin, soft slit strip, e.g. from a deep-drawable steel strip with a yield strength <300 N/mm² or deep-drawable aluminium with a yield strength <180 N/mm², in particular ultra-pure aluminium with a yield strength <150 N/mm². The wall thicknesses of the slit strip used are 0.3 mm, preferably between 0.2 and 0.1 mm or thinner in the case of alloyed material or steel. The films applied to the back can either be permanently applied to the slit strip as a protective or sacrificial film or in the form of a composite film.

The crimped sacrificial film or the composite film layer under the sheet to be embossed should be thin. The dimensions are adapted to the depth of the groove embossing. Preferred film thicknesses are 0.02 to 0.5 mm, even up to 0.1 mm. This also ensures that the foil does not accumulate in front of the roll gap or form a ‘bow wave’ that leads to peeling of the thin sheet.

In the case of a hard counter-pressure roller covered with an additional rubber skin, the film creates a two-layer pressure pad with different hardnesses and properties. While the film performs the greater deformation work, the hard rubber pad on the counter-pressure roller only serves to press down without a ‘bow wave’ building up in front of the roll gap and without the tips of the grooves digging deep into the rubber pad. The crushed sacrificial film thus also protects the hard rubber coating of the counter-pressure roller.

Rubber lamination of the flat counter-pressure roller is also advantageous so that the tips of the contour roller do not hit the steel of the counter-pressure roller when the embossed strip runs out of the tool, as the rollers are seated without a gap or are even deeper when the strip is very thin.

However, the innovation is not limited to the two-layer pressure pad. A multi-layer foil pad is also possible, as is embossing without an intermediate foil layer in a suitable rubber pad. The decisive factor is that no ‘bow wave’ accumulates in front of the roll gap. The advantage of the soft film, which is combined with the slit strip as a sacrificial film or composite film, is that—because the film is very thin—no ‘bow wave’ can form.

Furthermore, the risk of a ‘bow wave’ increases with the mechanical pressure and the depth of the creasing on the one hand and the increasing material hardness of the slit strip on the other. The depth of the creasing should therefore be <1 mm, preferably <0.5 mm.

Ideally, this results in the following structure:

Thin sheet slit strip ≤0.3 mm with an adhesive sacrificial film layer >0.2 mm for embossing V-shaped groove depths of preferably <0.5 mm and a rubberised counter-pressure roller with 70-80 Shore hardness A. In order to realise the sharp-edged tips of the prismatic groove formation, the mirror side is coated with an op-fer film, whereby the textured roller embosses into the slit strip from the rear. This process not only protects the mirror surface, but also increases the mirror lustre. However, it is also possible to emboss into the mirror surface in order to better mould the groove indentation. A particularly good result can be achieved if the embossing is carried out in two consecutive passes, whereby the position of the grooved roller and the counter-pressure roller are offset in the first and second pass, so that embossing is carried out first from one side and then from the other.

During the forming process, the thin sheet is essentially subjected to a load attack perpendicular to the surface. Experience shows that the strip runs out of the tool without twisting or corkscrewing.

In contrast to a classic embossing process, which only exerts pressure on the material to be embossed from one direction, the innovation involves a process that embosses from two sides simultaneously. The idea behind the invention is that the moulded plastic is deformed under pressure to form an embossing die!

While the classic embossing of the workpiece is only compacted at the embossing point, the innovative two-sided embossing additionally stretches the material. In contrast to the prior art from DE 10 2018 209927A1, the reshaping process is not carried out by tensile forces between roller tips, but rather exclusively by compressive forces in accordance with the invention.

The underlying plastic bed, into which the moulding process takes place, is preferably made of silicone rubber, rubber, an elastomer or PTFE. The sacrificial film is softer and the roller surface is harder.

It can be observed that an anodised strip material embossed using the innovative process is less brittle on the anodised surface and has fewer hairline cracks in the mirror surface compared to the forming process according to DE10 2018 209927A1 with two grooved rollers.

The purpose of anodising is to protect the surface and, in the case of bright anodised aluminium, to improve the mirror effect of the primary material. Hairline cracks in the surface of the stretched material, according to the state of the art, cause the surface to lose its lustre, become matt and fail to provide the desired mirror effect and oxidation protection.

Thanks to the innovative embossing process, the anodised surface nestles into the tool contour without losing its mirror finish. Particularly with vapour-deposited additional coatings or sputter layers, the gloss of the originally smooth surface is also retained on the embossed surface contour, as the vapour-deposited layer is extremely smooth and acts like a lubricant in the tool. The surface is obviously stretched, but cannot visibly crack under the simultaneous pressure on the surface. The mirror finish is retained. This is a major advantage of the innovation for producing mirror discs with special optics in line with the task at hand. Surface-finished products can therefore be used as the primary material for the innovative manufacturing process.

If a very thin sheet is embossed, it is necessary to stabilise the strip by means of co-extrusion, whereby the grooved sheet is backed with plastic in an extrusion tool after the sacrificial film has been removed.

FIG. 2 shows a greatly enlarged section of a typical preliminary product used to create grooves. It consists of a thin sheet 10 of thickness d1 and a protective film 11. The thickness d2 of the protective or sacrificial film can be thicker or thinner than d1. The thickness d2 also depends on the intended groove depth. The thin sheet preferably has a thickness d1 of <0.3 to 0.05 mm. The foil 11 can either be peeled off (sacrificial foil) or forms a solid bond with the thin sheet 10. The thin sheet 10 can be an alloyed aluminium strip, ultra-pure aluminium or a steel strip. Preferably, deep-drawable sheets are used. FIGS. 2 and 3 show an enlarged view of a thin sheet 0.2 mm thick and a protective film 0.4 mm thick.

The V-shaped creasing can be made in large working widths >1 m and split in a downstream work step, or it can be embossed in narrower lamella widths.

FIG. 3 shows a section of an idealised representation of a V-shaped groove embossing with isosceles grooves at an angle of 90° between a pair of rollers. The grooved pressure roller 17, which engages from above in the figure, has embossed the thin sheet on the upper side in the area of the valleys 12, 13. Due to the displacement of the soft, plastic film between the valleys, the plastic in the area 14, 15 presses the raised tips of the sheet metal strip upwards into the valleys on the underside of the grooved roller. The smooth counter-pressure roller 16 is made of steel.

The creasing results in extreme compaction of the plastic at the creased edges. These exert a strong deformation pressure in the opposite direction to the action of the grooved rollers. The intelligence of the process lies in the fact that it is primarily compressive forces that apply. A symmetrical groove pattern results in an exactly symmetrical load application at the grooves, which ensures that the strip warps less or not at all after the mould has run out. The depth of the groove embossing is H.

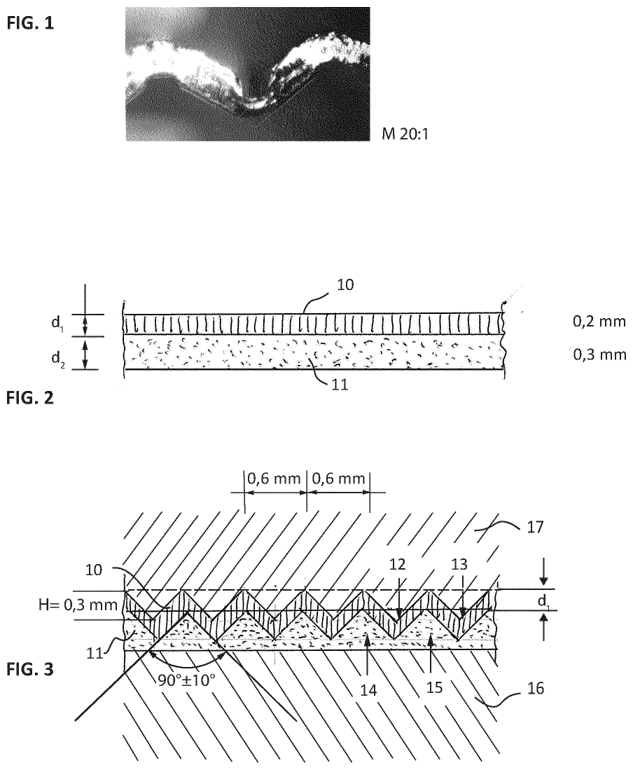

The thin sheet with an anodised or PVD or lacquer surface finish can be coated with a protective film either on the good side or on the reverse side, whereby the embossing roller embosses from the opposite side of the film coating. The embossing takes place either in the flat strip or, in the case of a concave/convex grooved roller with a concave/convex counter-pressure roller, in a concave/convex contour. FIGS. 1 and 2 show flat rollers.

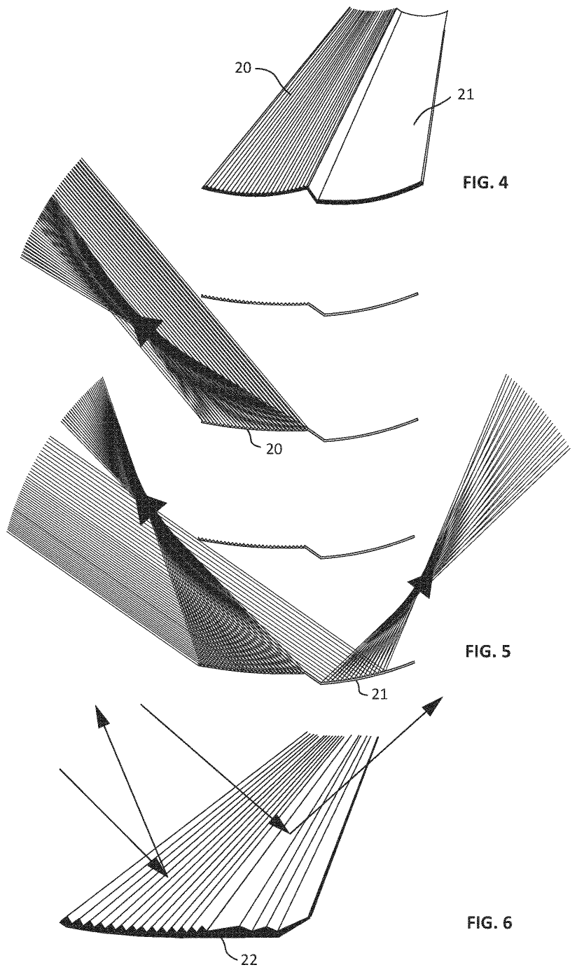

FIGS. 4 and 5 show the end product of a 50 mm wide retro Jalouise lamella. The incident side light is focussed on the retroreflector 20 due to the concave bulge and deflected back in the direction of the incident light. The parallel section 21 deflects the light in the opposite direction. This illustration helps to understand the requirements of the grooved product. The V-shaped grooves have an opening angle of preferably 90°±10° in the flat, grooved sheet metal strip. The grooved thin sheet is stabilised on the underside by means of co-extrusion. ABS or PVC, for example, is used for this purpose. The innovative manufacturing process includes coextrusion to produce stable light guide vanes, which is preferably carried out online, in that the coextrusion is preceded by grooving. The grooved thin sheet then only serves as a reflective surface for the plastic louvre.

FIG. 5 uses ray tracing to show the complex optics or ray guidance that is achieved by means of creasing. The ray tracing clearly shows that the mirror optics require a high moulding accuracy of the microstructured roller tools, which cannot be achieved with a rolling process according to the state of the art.

FIG. 6 shows a grooved thin sheet with a partially irregular groove structure according to the innovative process. The grooved thin sheet is combined with a support profile 22 by means of coextrusion. To avoid a bimetallic effect, the underside can also be covered with a smooth thin sheet.

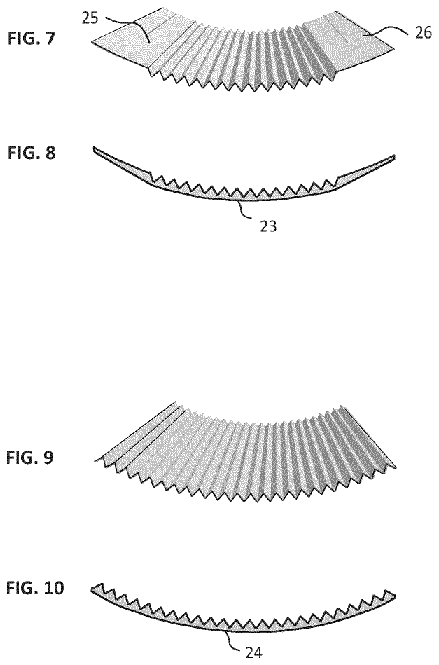

FIGS. 7, 8 show a concave/convex louvre with only a central groove. The strip is not grooved at the longitudinal edges 25, 26. FIG. 8 shows the slat with a plastic injection-moulded reinforcement 23, which is necessary if the hinge material is too thin to be used as a venetian blind slat without a plastic injection-moulded reinforcement.

FIGS. 9, 10 show a concave/convex louvre with grooves across its entire cross-section. In FIG. 10, the lamella is again under-moulded with plastic 24. The concave/convex contour can either be subsequently moulded into a flat, grooved strip or the grooves can be embossed in a concave/convex roller.

The advantage of subsequent concave/convex moulding is that the strips can be grooved in large widths in order to split them into slat widths in a further work step and only then can they be brought into a concave/convex shape.

The concave/convex shape stabilises the straightness of the slat. The thin sheet hardens during the forming process and tends to curl up after rolling. These tensions can be released from the rolled strip by a downstream straightening process. It is particularly advantageous to shape the strips concave/convex in the final contour after rolling and/or straightening. As a result of the hardness, the strips produced can be wound up again despite the groove-like stiffening. If the strips are later unwound from the winding roll in venetian blind machines, they spring back into a straight slat.

FIG. 7 shows belts that are only grooved in the centre of their cross-section and are smooth and/or curved or slightly angled at the edges 25, 26. This is only possible because the grooves are very fine and have a shallow depth, so that no large tension differences occur in the slit strip. This method is particularly suitable for creating mirror optics.

All groove representations in the figures show ideal contours with sharp groove peaks and precisely moulded groove valleys. The patent relates to a process for approximating these ideal contours. Depending on the raw material quality, the pressure build-up between the rollers and the Shore hardness into which the material is moulded, the material forms differently under the microscope. Radii inevitably occur at the groove peaks and especially in the groove valleys, which are not specified here and are not part of the manufacturing process.

I claim:

1. Method for embossing grooved microstructures into thin-walled sheet metal between two hard rollers for the production of venetian blind slats with at least partially metallically reflective and at least partially grooved upper surfaces for light deflection, comprising the following steps:
Providing a slit strip
arranging a thin, soft, elastic and/or plastic layer of plastic beyond the embossed sides
producing a creasing by embossing V-shaped grooves which run in the longitudinal direction of the slit strip to be embossed,
wherein the grooving is embossed in throughfeed between one or more pairs of rollers, wherein a pair of rollers consists of a hard embossing roller with a groove-shaped contour and a hard counterpressure roller without grooves, wherein the counterpressure roller is hard in relation to the soft embossing base formed by the thin, soft, elastic and/or plastic layer of plastic material
wherein the embossing is carried out in the thin sheet metal strip by embossing through the thin sheet metal into the soft plastic layer and
wherein the counter-pressure roller has a smooth, elastic, but harder or hard surface in relation to the embossing base, so that
the thin, soft, elastic and/or plastic plastic layer is crushed more strongly in the area of the groove edges and
by squeezing the soft, elastic and/or plastic layer of plastic material at the grooved edges, the thin sheet supports a form-fitting shaping in the groove valleys of the embossing roller due to displacement and thus a thin sheet grooved on both sides can be produced by means of a smooth counterpressure roller without grooves.

2. Grooved, stable sheet metal according to claim 1, characterised in that the thin sheet is deep-drawable and in that the thin sheet has a yield strength of <300 N/mm² in the case of steel and <180 N/mm² in the case of aluminium or an aluminium alloy or <150 N/mm² in the case of ultra-pure aluminium.

3. Process for embossing grooved microstructures according to claim 1, characterised in that the elastic and/or plastic layer consists of a single or multi-layer film, the film either being firmly joined to the thin sheet as a composite film or the film being removed after grooving.

4. Grooved, stable sheet metal according to claim 1 or 3, characterised in that a hard rubber coating is arranged on the hard counter-pressure roller and the rubber coating has a Shore hardness of preferably 70 to 80 A.

5. Grooved, stable sheet metal according to claim 1, characterised in that the elastic and/or plastic layer (11) has at least the thickness of the groove depth.

6. Grooved, stable sheet metal according to claim 1, characterised in that the thin sheet (10) has a material thickness of ≤0.3 mm, in particular of 0.05 to 0.2 mm, and the groove depth H is 0.03 to 1 mm and the thickness of the foil is 0.05 to 1.0 mm.

7. Grooved, stable sheet metal according to claim 1, characterised in that the grooved roller is concave or convex and that the smooth counter-pressure roller is correspondingly convex or concave, or one or more pairs of rollers for concave/convex shaping are arranged downstream of the grooving in the flat sheet, so that a stable, straight lamella can be produced.

8. Grooved, stable sheet metal according to claim 1 and/or 7, characterised in that the groove contour is introduced into a very thin sheet metal, preferably ≤0.2 mm thick, and is stabilisingly under-injected online in a coextrusion process by means of a plastic, so that a smooth underside is produced after the grooving.

9. Grooved, stable sheet metal according to claim 8, characterised in that the smooth underside is laminated with a metallic thin sheet.

10. Grooved, stable sheet metal according to claim 1 or 8 or 9, characterised in that the grooved, embossed thin sheet has at least partially a tooth-shaped cross-section with 90°±10 ° open grooves at least on its upper side and wherein at least individual V-shaped grooves consist essentially of flanks with equal legs and have groove spacings of at most 2 mm, preferably <1 mm, and the slit product serves as a slat intermediate product for an optical mirror system of a slat curtain.
